(19) United States
(12) Patent Application Publication
(10) Pub. No.: US 2018/0264772 A1
(43) Pub. Date: Sep. 20, 2018

(54) Rubber Composition and Layered Body

(71) Applicant: The Yokohama Rubber Co., LTD., Minato-ku, Tokyo (JP)

(72) Inventor: Koki Sugihara, Hiratsuka-shi, Kanagawa (JP)

(21) Appl. No.: 15/781,058

(22) PCT Filed: Oct. 28, 2016
(86) PCT No.: PCT/JP2016/082011

§ 371 Date: Jun. 1, 2018

(30) Foreign Application Priority Data
Dec. 2, 2015 (JP) 2015-235856

(51) Int. Cl. B32B 1/08; B32B 27/32; B32B 15/06; C08L 9/00; C08L 91/06; C08J 5/04; C08K 5/053

(52) U.S. Cl. CPC B32B 1/08; B32B 27/32; B32B 15/06; B32B 2597/00; C08L 91/06; C08J 5/041; C08K 5/053; C08L 9/00

(57) ABSTRACT

A rubber composition of the present technology includes: a diene polymer containing a butadiene rubber; and a polyhydric alcohol, a content of the polyhydric alcohol being from 0.5 parts by mass to 14 parts by mass per 100 parts by mass of the diene polymer.

### TECHNICAL FIELD

The present technology relates to a rubber composition and a layered body.

### BACKGROUND ART

For a known hose used for construction or the like (e.g. hydraulic hose), a layered body having a rubber layer and a reinforcing layer having a surface plated with a metal, such as brass, has been used. Furthermore, from the perspective of preventing wear due to contact with a rotation body, such as a pulley, a butadiene rubber having excellent wear resistance may be used for the rubber layer.

For example, Japan Unexamined Patent Publication No. 2012-051978 discloses a hydraulic hose including: a rubber layer formed by using a composition containing a butadiene rubber as a main component, and a brass-plated wire reinforcing layer that is located adjacent to the rubber layer (claims and the like).

When a hose including a rubber layer and a reinforcing layer having a metal surface is produced, vulcanization is typically performed after an unvulcanized rubber layer is formed on the reinforcing layer. Methods of the vulcanization at this time include mainly a steam vulcanization method of vulcanizing by heating with steam, and an oven vulcanization method of vulcanizing by heating in an oven. While the steam vulcanization method is performed in a sealed system and continuous production by the steam vulcanization method is difficult, the oven vulcanization method is performed in an open system, and continuous production is possible with the oven vulcanization method. From the perspective of productivity, the oven vulcanization method is desirable compared to the steam vulcanization method.

In such circumstances, when the inventor of the present technology produced a hose including a rubber layer formed from a rubber composition containing a butadiene rubber and a reinforcing layer having a metal surface, no problems were observed in adhesion between the rubber layer and the metal surface in the case of performing vulcanization by the steam vulcanization method. However, the inventor found that the adhesion between the rubber layer and the metal surface may be deteriorated in the case of performing the vulcanization by the oven vulcanization method, and the adhesion does not necessarily satisfy the level that is required recently.

Furthermore, although hoses used for construction or the like are often exposed to a hot and humid environment, it was also found that the adhesion is further deteriorated when the obtained hose is left in a hot and humid environment.

### SUMMARY

The present technology provides a rubber composition exhibiting excellent adhesion to a metal surface even when the vulcanization is performed by an oven vulcanization method as well as a steam vulcanization method, and exhibiting excellent adhesion even when being left in a hot and humid environment after the vulcanization; and a layered body including a rubber layer formed by using the rubber composition described above and a reinforcing layer having a metal surface.

The present technology includes the following features.

(1) A rubber composition including: a diene polymer containing a butadiene rubber, and a polyhydric alcohol,

a content of the polyhydric alcohol being from 0.5 parts by mass to 14 parts by mass per 100 parts by mass of the diene polymer.

(2) The rubber composition according to (1) above, where the polyhydric alcohol is glycerin.

(3) The rubber composition according to (1) or (2) above, further including a wax,

a content of the wax being 2 parts by mass or greater per 100 parts by mass of the diene polymer.

(4) A layered body including: a reinforcing layer having a metal surface, and a rubber layer provided on the metal surface,

the rubber layer being formed by using the rubber composition described in any one of (1) to (3) above.

(5) The layered body according to (4) above, where the reinforcing layer has a braided structure or a spiral structure formed by braiding wires.

(6) The layered body according to (4) or (5) above, the layered body being a hose.

As described below, according to the present technology, a rubber composition exhibiting excellent adhesion to a metal surface even when the vulcanization is performed by an oven vulcanization method as well as when the vulcanization is performed by a steam vulcanization method, and exhibiting excellent adhesion even when being left in a hot and humid environment after the vulcanization; and a layered body including a rubber layer formed by using the rubber composition described above and a reinforcing layer having a metal surface can be provided.

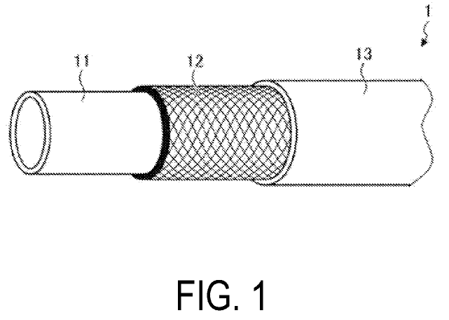

FIG. 1 is a partial cutaway perspective view of an embodiment of the hose of the present technology.

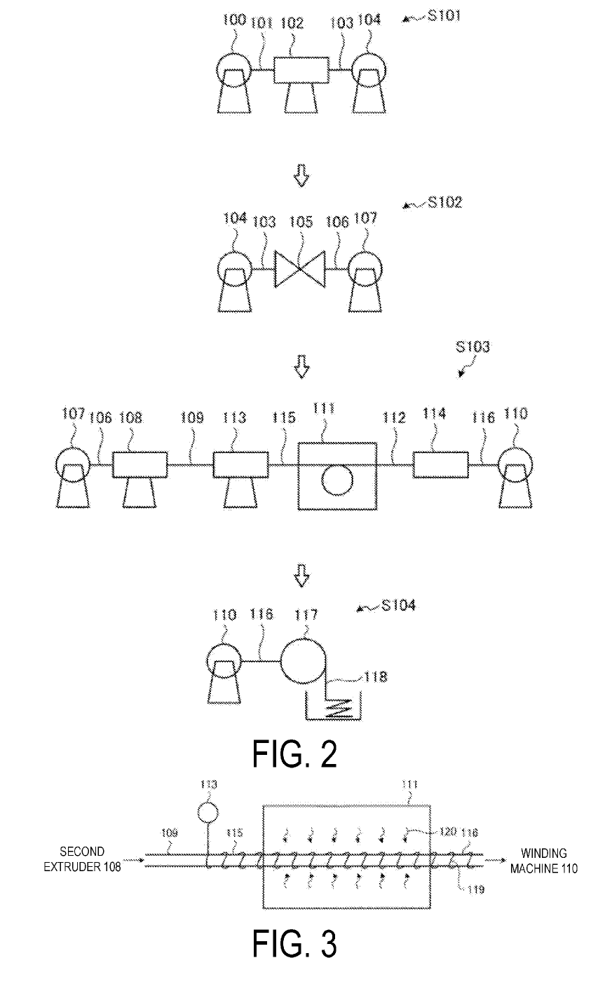

FIG. 2 is an explanatory diagram of an embodiment of production steps of producing a hose of an embodiment of the present technology.

FIG. 3 is an explanatory diagram of an embodiment of a vulcanization step among the production steps of producing the hose of an embodiment of the present technology.

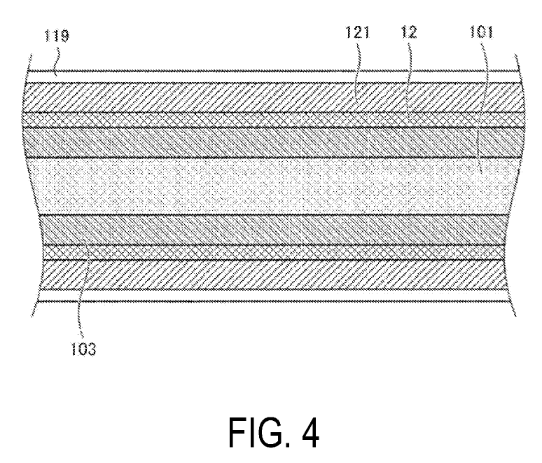

FIG. 4 is a partial cross-sectional view explaining an example of a layer structure around a mandrel inserted into a vulcanization device.

### DETAILED DESCRIPTION

The rubber composition and the layered body of embodiments of the present technology are described below.

Note that, in the present specification, numerical ranges indicated using “(from) . . . to . . . ” include the former number as the lower limit value and the later number as the upper limit value.

### Rubber Composition

The rubber composition of an embodiment of the present technology (hereinafter, also referred to as “composition of an embodiment of the present technology”) contains a diene polymer containing a butadiene rubber, and a polyhydric alcohol. Note that the content of the polyhydric alcohol is from 0.5 parts by mass to 14 parts by mass per 100 parts by mass of the diene polymer.

It is presumed that the predetermined effect can be achieved because the composition of an embodiment of the present technology contains a polyhydric alcohol. Although the reason is not clear, it is assumed to be as follows.

From the study of the inventor of the present technology, it is known that, when an unvulcanized rubber layer is formed by using a rubber composition in the reinforcing layer having a metal surface and then vulcanized, the bonding reaction between the rubber layer and the metal surface proceeds due to the moisture in the rubber composition serving as a catalyst, and as a result, the adhesion between the rubber layer and the metal surface is enhanced. Furthermore, it is known that the rubber composition is less likely to be dried when vulcanized by a steam vulcanization method due to the presence of abundant moisture, and thus the bond formation between the rubber layer and the metal surface sufficiently proceeds. On the other hand, it is known that the rubber composition is easily dried when vulcanized by an oven vulcanization method due to the presence of a small amount of moisture, it becomes difficult to proceed the bond formation between the rubber layer and the metal surface.

The present technology is based on the findings described above, and aims at promoting the bond formation between the rubber layer and the metal surface by blending a polyhydric alcohol. The action thereof is not clear; however, it is considered that the polyhydric alcohol having a hydroxy group supplements the reduced amount of the moisture in the rubber composition due to the heat during the vulcanization, and the polyhydric alcohol itself functions as a catalyst to form a bond between the rubber layer and the metal surface. As a result, it is presumed that the adhesion between the rubber layer and the metal surface becomes significantly excellent when the composition of an embodiment of the present technology is used.

Each of the components contained in the composition according to an embodiment of the present technology will be described in detail below.

### Diene Polymer

The diene polymer contained in the composition of an embodiment of the present technology contains a butadiene rubber (BR).

The content of the butadiene rubber in the diene polymer is preferably 10 mass % or greater, more preferably 20 mass % or greater, and even more preferably 30 mass % or greater. The upper limit thereof is not particularly limited but is preferably 90 mass % or less, more preferably 70 mass % or less, and even more preferably 50 mass % or less.

The diene polymer may contain another diene polymer besides the butadiene rubber. The diene polymer except the butadiene rubber is not particularly limited, and examples thereof include a natural rubber (NR), isoprene rubber (IR), aromatic vinyl-conjugated diene copolymer rubber, acrylonitrile-butadiene copolymer rubber (NBR), butyl rubber (IIR), halogenated butyl rubber (Br-IIR, Cl-IIR), chloroprene rubber (CR), ethylene-propylene-diene rubber (EPDM), chlorinated polyethylene rubber (CM), and chlorosulfonated polyethylene rubber (CSM). These may be used alone or in combination of two or more types.

The diene polymer except the butadiene rubber is preferably an aromatic vinyl-conjugated diene copolymer rubber, and more preferably a styrene-butadiene copolymer rubber (SBR).

When the diene polymer contains a diene polymer except the butadiene rubber, the content of the diene polymer except the butadiene rubber in the diene polymer is preferably from 10 to 90 mass %, and more preferably from 30 to 70 mass %.

### Polyhydric Alcohol

The polyhydric alcohol contained in the composition of an embodiment of the present technology is not particularly limited as long as the polyhydric alcohol is an alcohol having two or more hydroxy groups.

Examples of the polyhydric alcohol include ethylene glycol, diethylene glycol, 1,2-propane diol, 1,3-propane diol, 1,2-butane diol, 1,4-butane diol, 2-butene-1,4-diol, 2,3-butane diol, pentane diol, hexane diol, octane diol, dihydroxyacetone, 1,1,1-trishydroxymethylethane, 2-ethyl-2-hydroxymethyl-1,3-propane diol, 1,2,6-hexane triol, 1,2,3-hexane triol, 1,2,4-butane triol, trimethylolpropane, ascorbic acid, erythorbic acid, sugar alcohols, monosaccharides, and disaccharides, and trisaccharides.

Examples of the sugar alcohols include tritols including glycerin, tetritols such as erythritol and threitol, pentitols such as arabinitol, xylitol, and ribitol (adonitol), hexitols such as iditol, galactitol (dulcitol), glucitol (sorbitol), and mannitol, and heptitols such as volemitol and perseitol.

Examples of the monosaccharides include aldoses such as glyceraldehyde, threose, erythrose, ribose, arabinose, xylose, lyxose, allose, altrose, glucose, mannose, gulose, idose, galactose, and talose, and ketoses such as dihydroxyacetone, erythrulose, xylulose, ribulose, psicose, fructose, sorbose, tagatose, sedoheptulose, and coriose.

Examples of the disaccharides include non-reducing sugars such as sucrose, trehalose, isotrehalose (β,β-trehalose), neotrehalose (α,β-trehalose), and galactosucrose, and reducing sugars such as lactulose, lactose, maltose, cellobiose, kojibiose, nigerose, isomaltose, sophorose, laminaribiose, gentibiose, turanose, maltulose, palatinose, gentiobiose, mannobiose, melibiose, melibiulose, neolactose, scillabiose, rutinose, rutinulose, vicianose, xylobiose, and primeverose.

Examples of the trisaccharides include nigerotriose, maltotriose, melezitose, maltotriulose, raffinose, and kestose.

From the perspective of achieving superior adhesion, the polyhydric alcohol is preferably a compound represented by General Formula (1) below.

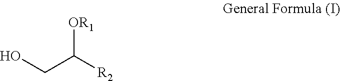

In General Formula (1), R₁ represents a mono or polyhydroxyalkyl group that may have a hydrogen atom or an ether bond and a branch and that has from 1 to 5 carbons, and R₂ represents a mono or polyhydroxyalkyl group that may have an ether bond and a branch and that has from 1 to 5 carbons.

In General Formula (1) above, examples of R₁ includes a hydroxymethyl group, a 1-hydroxyethyl group, a 2-hydroxyethyl group, a dihydroxyethyl group, a 1-hydroxypropyl group, a 2-hydroxypropyl group, a 3-hydroxypropyl group, a dihydroxypropyl group, a trihydroxypropyl group, a 1-hydroxybutyl group, a 2-hydroxybutyl group, a 3-hydroxybutyl group, a 4-hydroxybutyl group, a dihydroxybutyl group, a trihydroxybutyl group, a tetrahydroxybutyl group, a pentahydroxybutyl group, a 1-hydroxypentyl group, a 2-hydroxypentyl group, a 3-hydroxypentyl group, a 4-hydroxypentyl group, a 5-hydroxypentyl group, a dihydroxypentyl group, a trihydroxypentyl group, a tetrahydroxypentyl group, a pentahydroxypentyl group, a methoxymethyl group, a hydroxyethoxyethyl group, a dihydroxypropoxymethyl group, a dihydroxypropoxyethyl group, a trihydroxypropoxymethyl group, and a trihydroxypropoxyethyl group.

In General Formula (1) above, examples of R₂ includes a hydroxymethyl group, a 1-hydroxyethyl group, a 2-hydroxyethyl group, a dihydroxyethyl group, a 1-hydroxypropyl group, a 2-hydroxypropyl group, a 3-hydroxypropyl group, a dihydroxypropyl group, a trihydroxypropyl group, a 1-hydroxybutyl group, a 2-hydroxybutyl group, a 3-hydroxybutyl group, a 4-hydroxybutyl group, a dihydroxybutyl group, a trihydroxybutyl group, a tetrahydroxybutyl group, a pentahydroxybutyl group, a 1-hydroxypentyl group, a 2-hydroxypentyl group, a 3-hydroxypentyl group, a 4-hydroxypentyl group, a 5-hydroxypentyl group, a dihydroxypentyl group, a trihydroxypentyl group, a tetrahydroxypentyl group, a pentahydroxypentyl group, a methoxymethyl group, a hydroxyethoxyethyl group, a dihydroxypropoxymethyl group, a dihydroxypropoxyethyl group, a trihydroxypropoxymethyl group, and a trihydroxypropoxyethyl group.

Examples of the compound represented by General Formula (1) above include ethylene glycol, propylene glycol, butylene glycol, pentylene glycol, diethylene glycol, triethylene glycol, glycerin, 1,2,6-trihydroxyhexane, diglycerin, trimethylolpropane, pentaerythritol, sorbitol, and hexane triol. Among these, ethylene glycol, diethylene glycol, glycerin, hexane triol, diglycerin, and sorbitol are preferable, and glycerin is more preferable from the perspective of achieving superior adhesion.

The molecular weight of the polyhydric alcohol is not particularly limited but is preferably from 50 to 1000, and more preferably from 70 to 300.

The boiling point of the polyhydric alcohol is not particularly limited but is preferably from 100 to 400° C., and more preferably from 100 to 300° C. Note that the boiling point described above is a value at 1 atm.

In the composition of an embodiment of the present technology, the content of the polyhydric alcohol is from 0.5 parts by mass to 14 parts by mass per 100 parts by mass of the diene polymer described above. Within this range, the content is preferably from 1.0 to 10 parts by mass.

### Optional Component

The composition of an embodiment of the present technology may contain a component besides the diene polymer and the polyhydric alcohol. Examples of such a component include fillers, plasticizers, softeners, anti-aging agents, organic activators, antioxidants, antistatic agents, flame retardants, vulcanization accelerators, cross-linking accelerator aids, vulcanization retarders, ozone deterioration preventing agents, process oils (aroma oils), adhesion aids, waxes, fatty acid esters, and vulcanizing agents (e.g. sulfur).

Examples of the fillers include carbon black, silica (white carbon black), clay, talc, iron oxide, zinc oxide (ZnO), titanium oxide, barium oxide, magnesium oxide, calcium carbonate, magnesium carbonate, zinc carbonate, barium sulfate, mica, and diatomaceous earth. One type of these may be used alone, or two or more types of these may be used in a combination. As the carbon black, any carbon black can be suitably selected and used depending on the purpose. ISAF grade and FEF grade carbon blacks are preferable. Examples of the silica include crystallized silica, precipitated silica, amorphous silica (e.g. high temperature treated silica), fumed silica, calcined silica, pulverized silica, and molten silica. In particular, silica generates a carbon gel (bound rubber) similarly to carbon black and can be suitably used as necessary. Examples of the clay include hard clay, pyropyllite clay, kaolin clay, and calcined clay.

Examples of the plasticizer include dioctyl phthalate (DOP), dibutyl phthalate (DBP), dioctyl adipate (DOA), isodecyl succinate, di(ethylene glycol) dibenzoate, pentaerythritol ester, butyl oleate, methyl acetyl ricinoleate, tricresyl phosphate, trioctyl phosphate, trimellitic acid ester, propylene glycol adipate polyester, butylene glycol adipate polyester, and naphthenic oil. One type of these may be used alone, or two or more types of these may be used in a combination.

Specific examples of the softener include aromatic oil, naphthenic oil, paraffinic oil, petroleum resin, vegetable oil, and liquid rubber. One type of these may be used alone, or two or more types of these may be used in a combination.

Examples of the anti-aging agent include N-(1,3-dimethylbutyl)-N′-phenyl-p-phenylenediamine (6PPD), N,N′-dinaphthyl-p-phenylenediamine (DNPD), N-isopropyl-N′-phenyl-p-phenylenediamine (IPPD), styrenated phenol (SP), and 2,2,4-trimethyl-1,2-dihydroquinoline polymer (RD). One type of these may be used alone, or two or more types of these may be used in combination.

Examples of the organic activator include stearic acid, oleic acid, lauric acid, and zinc stearate. One type of these may be used alone, or two or more types of these may be used in a combination.

Examples of the antioxidant include butylhydroxytoluene (BHT) and butylhydroxyanisole (BHA).

Examples of the antistatic agent include quaternary ammonium salts;

and hydrophilic compounds such as polyglycols and ethylene oxide derivatives.

Examples of the flame retardant include chloroalkyl phosphates, dimethyl-methyl phosphonates, bromine-phosphorus compounds, ammonium polyphosphates, neopentyl bromide polyethers, and brominated polyethers. Examples of the non-halogen-based flame retardant include aluminum hydroxide, magnesium hydroxide, tricresyl phosphate, and diphenyl cresyl phosphate.

As the cross-linking accelerator aid, a typical auxiliary for rubbers, can be used in combination. As the auxiliary for rubbers, zinc oxide; stearic acid, oleic acid, and Zn salts of these can be used.

Examples of the adhesive auxiliary include triazine thiol compounds (e.g. 2,4,6-trimercapto-1,3,5-triazine and 6-butylamino-2,4-dimercapto-1,3,5-triazine), resorcin, cresol, resorcin-formalin latex, monomethylol melamine, monomethylol urea, ethylene maleimide, cobalt naphthenate, cobalt stearate, cobalt versatate, and cobalt dodecanoate. One type of these adhesive auxiliaries may be used alone, or two or more types of these adhesive auxiliaries may be used in combination.

The composition of an embodiment of the present technology preferably contains a wax.

The wax is not particularly limited, and examples thereof include vegetable waxes such as rice wax, candelilla wax, carnauba wax, Japan wax, urushi wax, sugarcane wax, and palm wax, mineral waxes such as montan wax, ozokerite, ceresin, and wax obtained by oil shale, and animal waxes such as beeswax. Among these, microcrystalline wax and paraffin wax are preferable.

The content of the wax in the composition of an embodiment of the present technology is not particularly limited but is preferably 2 parts by mass or greater per 100 parts by mass of the diene polymer described above. The upper limit is not particularly limited but is preferably 10 parts by mass or less.

### Preparation Method of Rubber Composition

The composition of an embodiment of the present technology can be produced by a known production method. Examples thereof include a method in which the components described above are kneaded by using an internal mixer such as a Banbury mixer or a kneader, a roll kneader such as a roll, an extruder, and a twin screw extruder.

### Layered Body

The layered body of an embodiment of the present technology includes a reinforcing layer having a metal surface and a rubber layer provided on the metal surface. Note that the rubber layer is formed by using the composition of an embodiment of the present technology described above.

As described above, since the composition of an embodiment of the present technology exhibits excellent adhesion to a metal surface, the layered body of an embodiment of the present technology is suitably used for hoses (in particular, high pressure hoses and hydraulic hoses).

Hose

The case where the layered body of an embodiment of the present technology is a hose is described in detail below.

FIG. 1 is a partial cutaway perspective view of the hose of an embodiment of the present technology. As illustrated in FIG. 1, the hose 1 is formed cylindrically and includes an inner rubber layer 11 for passing fluid therein, a reinforcing layer 12 provided on the outer side of the inner rubber layer 11, and an outer rubber layer 13 provided on the outer side of the reinforcing layer 12. Note that the reinforcing layer 12 has a metal surface. Furthermore, the inner rubber layer 11 and/or the outer rubber layer 13 are formed by using the composition of an embodiment of the present technology described above. The reinforcing layer 12 is arranged in the manner that the inner rubber layer 11 and the outer rubber layer 13 sandwich the reinforcing layer 12. The inner rubber layer 11, the reinforcing layer 12, and the outer rubber layer 13 are adhered and fixed due to the vulcanization of the inner rubber layer 11 and the outer rubber layer 13.

Each of the layers will be described and then a specific example of producing the hose of an embodiment of the present technology will be described in detail below.

### Reinforcing Layer

The reinforcing layer is a layer to maintain the strength of the hose, and from the perspective of adhesion to the rubber layer, the reinforcing layer has a metal surface. The reinforcing layer is a wire braid in which steel wires preferably having a surface plated with brass are braided. Note that, in the example illustrated in FIG. 1, the reinforcing layer is one layer; however, a plurality of the reinforcing layers between which a middle rubber layer is provided may be provided. The reinforcing layer may be, other than a wire braid, spiral wires formed by winding steel wires spirally around the inner rubber layer. Materials for forming the reinforcing layer, and a braiding method, weaving method, or winding method of forming the reinforcing layer can be suitably selected depending on the application, for example depending on pressure resistance. In the hydraulic hose and the like, the reinforcing layer is preferably formed by a wire braid. The reinforcing layer preferably has a braided structure or a spiral structure formed by braiding wires.

Examples of the wire materials include piano wires (carbon steel), hard steel wires, and stainless steel wires. From the perspective of processability and strength, piano wires (carbon-steel) and hard steel wires are particularly preferable as the wire materials.

To enhance the adhesion to the rubber layer, the surface of the reinforcing layer is preferably plated with a metal. This metal plating is a brass coating applied on piano wires and hard steel wires. The brass coating is formed by plating a steel wire with copper, plating with zinc over the copper, and then subjecting the wire to thermal diffusion processing.

### Rubber Layer

The rubber layer is formed by using the composition of an embodiment of the present technology described above. From the perspective of weather resistance, at least the outer rubber layer is preferably formed by using the composition of an embodiment of the present technology described above. The inner rubber layer is preferably formed by using a rubber composition containing an acrylonitrile butadiene rubber (NBR) having excellent oil resistance as a main component.

The method of forming a rubber layer by using the composition of an embodiment of the present technology is not particularly limited, and examples thereof include a method in which a layer of the rubber composition is formed on a metal surface of a reinforcing layer and then vulcanized. By the vulcanization, the rubbers are crosslinked each other by a vulcanizing agent such as sulfur, and elasticity and tensile strength are imparted, and also the rubber layer and the reinforcing layer are bonded due to the bonding between the metal and the vulcanizing agent (e.g. sulfur) in the interface with the reinforcing layer.

When sulfur is used as the vulcanizing agent, the sulfur is preferably blended together with other materials when a compound of the rubber composition is formed. Note that the time at which sulfur is blended is not limited to the time when the compound is prepared as long as molecular chains forming the diene polymer are crosslinked each other by the sulfur, and as long as the rubber layer is adhered to the reinforcing layer due to the bond formed between the sulfur and the metal at the interface between the rubber layer and the reinforcing layer, for example.

Examples of the method of vulcanization include a method in which the rubber composition is heat-treated at a predetermined temperature for a predetermined time period in the presence of sulfur. The vulcanization temperature is preferably from 130° C. to 180° C. The vulcanization time is preferably from 30 minutes to 240 minutes. By a combination of the temperature and the time in these ranges, superior physical properties, such as elasticity, tensile strength, appearance, adhesion at the interface between the rubber and the metal, and rubber sticking at the interface between the rubber and the metal, can be imparted.

Examples of the vulcanization method include a steam vulcanization method in which a layer of the rubber composition is formed on a metal surface of a reinforcing layer, sealed in a high-pressure container, and crosslinked in a boiler, an oven vulcanization method in which a material covered by nylon cloth or the like is vulcanized in a hot air drying furnace. In general, the steam vulcanization method is a batch type treatment, and the oven vulcanization method is a continuous type treatment. From the perspective of productivity, the oven vulcanization method which is a continuous treatment is preferable.

Note that the present technology can be, needless to say, suitably employed in production of rubber products using known another vulcanization method. Examples of another vulcanization method include press vulcanization, steam vulcanization, hot water vulcanization.

The thickness of the inner rubber layer is, for example, preferably from 0.2 mm to 4.0 mm, and more preferably from 0.5 mm to 2.0 mm. Similarly, the thickness of the outer rubber layer is, for example, preferably from 0.2 mm to 4.0 mm, and more preferably from 0.5 mm to 2.0 mm.

### Production Method

A specific example of a method of producing a hose of an embodiment of the present technology is described below, with reference to FIGS. 2 and 3.

FIG. 2 is an explanatory diagram of an embodiment of production steps of producing a hose of an embodiment of the present technology. FIG. 3 is an explanatory diagram of an embodiment of a vulcanization step among the production steps of producing the hose of an embodiment of the present technology.

As illustrated in FIG. 2, the hose is obtained by an extrusion step of a rubber material that forms the inner rubber layer 11 (step S101), a braiding step of the reinforcing layer 12 (step S102), an extrusion-vulcanization step of the outer rubber layer 13 (step S103), and a removing step of mandrel 101 (step S104). The produced hose is subjected to a water pressure test and a winding test step, and then packaged and shipped.

In the step S101, the outer circumferential surface of a mandrel 101 that is sent out from an unwinding machine 100 is covered by an unvulcanized inner rubber layer 103 via a first extruder 102. The unvulcanized inner rubber layer 103 is wound by a winding-unwinding machine 104.

Next, in the step S102, a reinforcing layer is braided by a braiding machine 105 in the manner that the unvulcanized inner rubber layer 103 sent out from the winding-unwinding machine 104 is covered, to form an unvulcanized inner rubber layer with a reinforcing layer 106, and then the unvulcanized inner rubber layer with a reinforcing layer 106 is wound by the winding-unwinding machine 107. A metal wire is used as the code of this reinforcing layer. As the metal wire, a steel wire plated with brass is used to impart excellent adhesion to rubber. Note that the reinforcing layer may be formed by spirally winding the metal wire around the unvulcanized inner rubber layer 103 formed around the mandrel 101.

Next, in the step S103, a hose precursor 109 is formed by covering the reinforcing layer of the unvulcanized inner rubber layer with a reinforcing layer 106 sent out from the winding-unwinding machine 107 with an unvulcanized outer rubber layer by using a second extruder 108, and the formed hose precursor 109 is wound by a winding machine 110. In this step, a vulcanized hose obtained by a vulcanization step performed by a vulcanization device 111 is wound by the winding machine 110 after the hose precursor 109 is sent out from the second extruder 108 but before being wound by the winding machine 110. However, the vulcanization step can be performed after the hose precursor 109 is wound by the winding machine 110. Furthermore, before and after the vulcanization device 111, a wrapping device 113 and an unwrapping device 114 are provided to wrap or unwrap a protective cloth such as nylon cloth around the hose precursor 109. Note that, in FIG. 2, after the vulcanization, the hose precursor with nylon cloth 115 on which nylon cloth is wrapped by the wrapping device 113 becomes a hose with nylon cloth 112 that is in a state before unwrapping the nylon cloth. The vulcanization step will be described below.

Next, in the step S104, a hose 118 is completed by removing the mandrel 101, using a mandrel removing device 117, from the hose 116 that is sent out from the winding machine 110 and unwrapped after the vulcanization.

As illustrated in FIG. 3, nylon cloth 119 is wrapped around the hose precursor 109 sent out from the second extruder 108 by the wrapping device 113. The hose precursor with nylon cloth 115 covered with the nylon cloth 119 is then transferred into the vulcanization device 111. The vulcanization device 111 is a continuous vulcanization device with hot-air circulation that allows the vulcanization to proceed by hot wind 120. The vulcanization method is an oven vulcanization method. The vulcanization method may be a vulcanization method except the oven vulcanization method, such as a steam vulcanization method; however, from the perspective of enhancing productivity, the oven vulcanization method is preferable.

FIG. 4 is a partial cross-sectional view explaining an example of a layer structure around a mandrel inserted into a vulcanization device. As illustrated in FIG. 4, the unvulcanized inner rubber layer 103 is formed around the mandrel 101, the reinforcing layer 12 is further formed therearound, and the unvulcanized outer rubber layer 121 is further formed therearound. The nylon cloth 119 is wrapped around the unvulcanized outer rubber layer 121, and the unvulcanized outer rubber layer 121 is heated in this condition to proceed the vulcanization step.

As described above, the vulcanization temperature is preferably from 130° C. to 180° C., and the vulcanization time (that is, the vulcanization time in the vulcanization device 111) is preferably from 30 minutes to 240 minutes. Using this temperature range and the vulcanization time, a hose having superior adhesion between the inner rubber layer and the reinforcing layer and between the outer rubber layer and the reinforcing layer is obtained. In this step, a hose having excellent adhesion between an inner rubber layer and/or an outer rubber layer and a metal reinforcing layer can be produced by forming the inner rubber layer and/or the outer rubber layer using the composition of an embodiment of the present technology described above.

Furthermore, in the embodiment described above, production steps of continuous treatment are exemplified. The production is also possible by a method in which the rubber layer and the reinforcing layer are produced in separate steps and then adhered.

### Use

The hose of an embodiment of the present technology can be used in various applications. The hose of an embodiment of the present technology can be suitably used as, for example, air conditioner hoses for vehicles, power steering hoses, and hydraulic hoses for hydraulic systems of construction vehicles.

Furthermore, for example, the present technology can be similarly employed in other rubber layered bodies, such as conveyor belts.

### EXAMPLES

Embodiments of the present technology are described in further detail below. However, the present technology is not limited to these embodiments.

### Preparation of Rubber Composition

The components shown in Table 1 below were kneaded in the proportion (part by mass) shown in Table 1 below by using a Banbury mixer to prepare a rubber composition.

Note that, in Table, for the amount of SBR, the value in the upper row is the amount of SBR (oil extended product) (unit: part by mass), and the value in the lower row is the net amount of SBR contained in the SBR (unit: part by mass).

### Production of Hose

A reinforcing layer having a metal surface was formed on a mandrel having an outer diameter of 34 mm by winding brass-plated wires in a braided form around the mandrel. An unvulcanized sheet prepared from each of the obtained rubber compositions and having a thickness of 2.5 mm was then adhered on the metal surface of the reinforcing layer. Furthermore, a piece of curing tape (protective cloth) made from nylon 66 was wound around to cover the outer side of the unvulcanized sheet, and then vulcanization was performed by a steam vulcanization method (in a boiler at 142° C. for 90 minutes) or an oven vulcanization method (in a normal pressure oven at 142° C. for 135 minutes). As described above, a hose including a reinforcing layer having a metal surface and a rubber layer (outer side rubber layer) provided on a metal surface of the reinforcing layer was obtained.

### Evaluation of Adhesion

The peel strength (kN/m) and the rubber sticking (%) were evaluated for the obtained hoses (steam vulcanization method, oven vulcanization method). The results are shown in Table 1 (before hot and humid aging test). Note that the peel strength (kN/m) is a degree of force (kN) per a unit width (m) required to peel off the outer side rubber layer from the reinforcing layer (at peeling rate of 50 mm/min).

Furthermore, the rubber sticking is a proportion of the outer side rubber layer remaining on the reinforcing layer surface after the outer side rubber layer was peeled off, and is indicated by a percentage of the area proportion of the remaining rubber layer relative to the entire surface area of the reinforcing layer.

Each of the values of the peel strength (kN/m) and the rubber sticking (%) is an average value of ten measurements.

From the perspective of adhesion, the peel strength is preferably 3.5 kN/m or greater, and the rubber sticking is preferably 70% or greater.

Furthermore, after the obtained hose (steam vulcanization method, oven vulcanization method) was left in a hot and humid environment (50° C. and a relative humidity of 95%) for 1 week, adhesion was evaluated by the same method. The results are shown in Table 1 (after hot and humid aging test).

Evaluation of Bloom Resistance

The obtained hose (oven vulcanization method, before hot and humid aging test) was left in an environment at 25° C. for 6 weeks. Thereafter, the surface of the outer side rubber layer was observed or actually touched to evaluate the bloom resistance of the wax based on the following criteria. The results are shown in Table 1. A or B is preferable, and A is more preferable.
A: No bloom was observed, and the same condition was maintained after the vulcanization.
B: Slight bloom of the wax was observed.
C: Significant bloom of the wax was observed.

TABLE 1

| | | | Example | Example | Example | Example |
|---|---|---|---|---|---|---|
| | | | 1 | 2 | 3 | 4 |
| SBR | | | 90 | 90 | 90 | 90 |
| | | | (65) | (65) | (65) | (65) |
| BR | | | 35 | 35 | 35 | 35 |
| C.B | | | 70 | 70 | 70 | 70 |
| Plasticizer | | | 17 | 17 | 17 | 17 |
| Zinc oxide | | | 3 | 3 | 3 | 3 |
| Stearic acid | | | 1 | 1 | 1 | 1 |
| Anti-aging agent | | | 3 | 3 | 3 | 3 |
| WAX 1 | | | 1.6 | 1.6 | 1.6 | 1.6 |
| WAX 2 | | | 0.7 | 0.7 | 0.7 | 0.7 |
| Fatty acid ester | | | 2.4 | 2.4 | 2.4 | 2.4 |
| Polyhydric alcohol | | | 1.0 | 1.8 | 2.0 | 2.5 |
| Sulfur | | | 2 | 2 | 2 | 2 |
| Vulcanization accelerator 1 | | | 1 | 1 | 1 | 1 |
| Vulcanization accelerator 2 | | | 0.5 | 0.5 | 0.5 | 0.5 |
| Steam | Before hot and | Peel | 4.3 | 4.4 | 4.3 | 4.2 |
| vulcanization | humid aging test | strength | | | | |
| method | | Rubber | 100 | 100 | 100 | 100 |
| | | sticking | | | | |
| | After hot and | Peel | 4.2 | 4.0 | 4.3 | 4.1 |
| | humid aging test | strength | | | | |
| | | Rubber | 100 | 100 | 100 | 100 |
| | | sticking | | | | |
| Oven vulcanization | Before hot and | Peel | 4.4 | 4.4 | 4.1 | 4.6 |
| method | humid aging test | strength | | | | |
| | | Rubber | 100 | 100 | 100 | 100 |
| | | sticking | | | | |
| | After hot and | Peel | 4.5 | 3.6 | 4.1 | 4.4 |
| | humid aging test | strength | | | | |
| | | Rubber | 100 | 100 | 100 | 100 |
| | | sticking | | | | |
| Bloom resistance | | | A | A | A | A |
| | | | Example | Comparative | Comparative | |
| | | | 5 | Example 1 | Example 2 | |
| SBR | | | 90 | 90 | 90 | |
| | | | (65) | (65) | (65) | |
| BR | | | 35 | 35 | 35 | |
| C.B | | | 70 | 70 | 70 | |
| Plasticizer | | | 17 | 17 | 17 | |
| Zinc oxide | | | 3 | 3 | 3 | |
| Stearic acid | | | 1 | 1 | 1 | |
| Anti-aging agent | | | 3 | 3 | 3 | |
| WAX 1 | | | 1.6 | 1.6 | 1.6 | |
| WAX 2 | | | 0.7 | 0.7 | 0.7 | |
| Fatty acid ester | | | 2.4 | 2.4 | 2.4 | |
| Polyhydric alcohol | | | 12 | | 0.2 | |
| Sulfur | | | 2 | 2 | 2 | |
| Vulcanization accelerator 1 | | | 1 | 1 | 1 | |
| Vulcanization accelerator 2 | | | 0.5 | 0.5 | 0.5 | |
| Steam | Before hot and | Peel | 4.1 | 4.4 | 4.4 | |
| vulcanization | humid aging | strength | | | | |
| method | test | Rubber | 100 | 100 | 100 | |
| | | sticking | | | | |
| | After hot and | Peel | 4.1 | 4.4 | 4.4 | |
| | humid aging | strength | | | | |
| | test | Rubber | 100 | 100 | 100 | |
| | | sticking | | | | |
| Oven | Before hot and | Peel | 4.0 | 3.6 | 3.3 | |
| vulcanization | humid aging | strength | | | | |
| method | test | Rubber | 70 | 40 | 50 | |
| | | sticking | | | | |
| | After hot and | Peel | 4.0 | 3.1 | 3.2 | |
| | humid aging | strength | | | | |
| | test | Rubber | 100 | 10 | 30 | |
| | | sticking | | | | |
| Bloom resistance | | | B | A | A | |
| | | | Comparative | Comparative | Comparative | |
| | | | Example 3 | Example 4 | Example 5 | |
| SBR | | | 90 | 90 | 90 | |
| | | | (65) | (65) | (65) | |
| BR | | | 35 | 35 | 35 | |
| C.B | | | 70 | 70 | 70 | |
| Plasticizer | | | 17 | 17 | 17 | |
| Zinc oxide | | | 3 | 3 | 3 | |
| Stearic acid | | | 1 | 1 | 1 | |
| Anti-aging agent | | | 3 | 3 | 3 | |
| WAX 1 | | | 1.6 | 1.6 | 1.6 | |
| WAX 2 | | | 0.7 | 0.7 | 0.7 | |
| Fatty acid ester | | | 2.4 | 2.4 | 2.4 | |
| Polyhydric alcohol | | | 15 | | | |
| Sulfur | | | 2 | 2.3 | 2.6 | |
| Vulcanization accelerator 1 | | | 1 | 1 | 1 | |
| Vulcanization accelerator 2 | | | 0.5 | 0.5 | 0.5 | |
| Steam | Before hot | Peel | 4.1 | 4.2 | 3.8 | |
| vulcanization | and humid | strength | | | | |
| method | aging test | Rubber | 65 | 100 | 100 | |
| | | sticking | | | | |
| | After hot | Peel | 4.2 | 4.1 | 3.9 | |
| | and humid | strength | | | | |
| | aging test | Rubber | 50 | 100 | 100 | |
| | | sticking | | | | |
| Oven | Before hot | Peel | 3.9 | 4.4 | 4.1 | |
| vulcanization | and humid | strength | | | | |
| method | aging test | Rubber | 60 | 85 | 85 | |
| | | sticking | | | | |
| | After hot | Peel | 3.8 | 3.9 | 3.2 | |
| | and humid | strength | | | | |
| | aging test | Rubber | 100 | 40 | 20 | |
| | | sticking | | | | |
| Bloom resistance | | | C | B | C | |

The details of each component shown in Table 1 above are as follows.
SBR: styrene-butadiene rubber (Taipol 1723) (oil extended product: 37.5 parts by mass of extender oil was contained per 100 parts by mass of rubber; net amount of SBR was 72.7 mass %)
BR: butadiene rubber (NIPOL BR 1220)
C.B: ISAF grade carbon black (Shoblack N220, available from Cabot Japan K.K.)
Plasticizer: aromatic oil (A/O MIX 2010, available from Sankyo Yuka Kogyo K.K.)
Zinc oxide: Zinc Oxide III (available from Seido Chemical Industry Co., Ltd.)
Stearic acid: stearic acid
Anti-aging agent: N-phenyl-N′-(1,3-dimethylbutyl)-p-phenylenediamine (OZONONE 6C, available from Seiko Chemical Co., Ltd.)
WAX 1: microcrystalline wax (HI-MIC-1080, available from Nippon Seiro Co., Ltd.)
WAX 2: paraffin wax (OZOACE-0015, available from Nippon Seiro Co., Ltd.)
Fatty acid ester: fatty acid ester (NEW AID EG-ROLL, available from Seiko Chemical Co., Ltd.)
Polyhydric alcohol: glycerin (molecular weight: 92; boiling point: 290° C.; purified glycerin; available from Sakamoto Yakuhin Kogyo Co., Ltd.)
Sulfur: sulfur (available from Hosoi Chemical Industry Co., Ltd.)
Vulcanization accelerator 1: N-t-butylbenzothiazole-2-sulfenamide (NOCCELER NS-P, available from Ouchi Shinko Chemical Industrial Co., Ltd.)
Vulcanization accelerator 2: diphenylguanidine (Soxinol D-G, available from Sumitomo Chemical Co., Ltd.)

As is clear from Table 1, compared to Comparative Example 1 which contained no polyhydric alcohol, Examples 1 to 5 which contained the predetermined amount of the polyhydric alcohol exhibited excellent adhesion in the case where the vulcanization was performed by the oven vulcanization method as well as in the case where the vulcanization was performed by the steam vulcanization method. Furthermore, excellent adhesion was exhibited even after the samples were left in a hot and humid environment after the vulcanization. Among these, Examples 1 to 4 in which the content of the polyhydric alcohol was 10 parts by mass or less per 100 parts by mass of the diene polymer exhibited excellent bloom resistance. Among these, Example 4, in which the content of the polyhydric alcohol was 2.5 parts by mass or greater per 100 parts by mass of the diene polymer, exhibited superior adhesion to the case where the vulcanization was performed by the oven vulcanization method.

On the other hand, Comparative Example 2, in which the content of the polyhydric alcohol was less than 0.5 parts by mass per 100 parts by mass of the diene polymer although the polyhydric alcohol was contained, exhibited insufficient adhesion in the case where the vulcanization was performed by the oven vulcanization method, similarly to the case of Comparative Example 1. Furthermore, Comparative Example 3, in which the content of the polyhydric alcohol was greater than 14 parts by mass per 100 parts by mass of the diene polymer although the polyhydric alcohol was contained, exhibited insufficient adhesion in the case where the vulcanization was performed by the steam vulcanization method.

Furthermore, Comparative Examples 4 and 5, in which the content of the sulfur was increased while no polyhydric alcohol was contained, exhibited insufficient adhesion in the case where the samples were left in the hot and humid environment after the vulcanization (oven vulcanization method).

1. A rubber composition comprising:
a diene polymer containing a butadiene rubber; and
a polyhydric alcohol,
a content of the polyhydric alcohol being from 0.5 parts by mass to 14 parts by mass per 100 parts by mass of the diene polymer.

2. The rubber composition according to claim 1, wherein the polyhydric alcohol is glycerin.

3. The rubber composition according to claim 1, further comprising a wax,
a content of the wax being 2 parts by mass or greater per 100 parts by mass of the diene polymer.

4. A layered body comprising:
a reinforcing layer having a metal surface; and
a rubber layer provided on the metal surface,
the rubber layer being formed by using the rubber composition described in claim 1.

5. The layered body according to claim 4, wherein the reinforcing layer has a braided structure or a spiral structure formed by braiding wires.

6. The layered body according to claim 4, the layered body being a hose.

7. The rubber composition according to claim 2, further comprising a wax,
a content of the wax being 2 parts by mass or greater per 100 parts by mass of the diene polymer.

8. A layered body comprising:
a reinforcing layer having a metal surface; and
a rubber layer provided on the metal surface,
the rubber layer being formed by using the rubber composition described in claim 7.

9. A layered body comprising:
a reinforcing layer having a metal surface; and
a rubber layer provided on the metal surface,
the rubber layer being formed by using the rubber composition described in claim 2.

10. A layered body comprising:
a reinforcing layer having a metal surface; and
a rubber layer provided on the metal surface,
the rubber layer being formed by using the rubber composition described in claim 3.

11. The layered body according to claim 5, the layered body being a hose.
